(19) United States
(12) Patent Application Publication
(10) Pub. No.: US 2026/0021693 A1
(43) Pub. Date: Jan. 22, 2026

(54) Embedded hard cover

(71) Applicant: Yunyan He, Hangzhou (CN)

(72) Inventors: Shaoyong Zheng, Hangzhou (CN); Yunyan He, Hangzhou (CN)

(21) Appl. No.: 19/016,169

(22) Filed: Jan. 10, 2025

(30) Foreign Application Priority Data
Jul. 19, 2024 (CN) 202410972356.5

(51) Int. Cl. B60J 7/14; B60J 7/19; B60J 10/16; B60J 10/90

(52) U.S. Cl. CPC B60J 7/141; B60J 7/198; B60J 10/16; B60J 10/90

(57) ABSTRACT

The present invention discloses an embedded hard cover, comprising a car cover body and a guide rail system. The car cover body comprises a large front rail system, a guide rail system, a rear rail, multiple plate bodies, and multiple rotating shafts. The central hole of the large front rail corresponds to a front plate unlocking mechanism; the unlocking mechanism can simultaneously drive two front panel locks to unlock, making it convenient to operate.

### CROSS-REFERENCE TO RELATED APPLICATIONS

This application claims priority benefits to Chinese Patent Application No. 202410972356.5, filed on Jul. 19, 2024, the contents of which are incorporated herein by reference.

### TECHNICAL FIELD

The present invention belongs to the field of pickup truck covers and specifically relates to an embedded hard cover.

### BACKGROUND TECHNOLOGY

Pickup trucks are an important component of the automotive market. Pickup trucks are a type of vehicle that uses a sedan front and driver's cab, as well as an open truck compartment. They are characterized by both sedan like comfort and strong power, and are even more capable of carrying goods and adapting to poor road conditions than sedans. The most common pickup truck model is a double row pickup truck, which can be used as a dedicated vehicle, multi-purpose vehicle, official vehicle, and business vehicle, as well as a household vehicle for carrying goods, traveling, and renting. The so-called “pickup truck” is a hybrid of sedan and truck. With the expansion of the scale of modification enthusiasts, pickup truck modification has become an increasingly popular category among modification enthusiasts.

The existing pickup truck covers are divided into soft covers and hard covers. For hard covers, the front grille is usually difficult to open, making it difficult to fully open the hard pickup truck cover. Secondly, due to the inconvenience of installing waterproof skin, how to effectively waterproof the hard cover is also one of the main problems faced.

### SUMMARY OF THE INVENTION

In order to solve the above-mentioned problems in the existing technology, the technical solution adopted by the present invention is:
An embedded hard cover comprising a hood body and a guide rail system, wherein the hood body comprises a large front rail system, a guide rail system, a rear rail, multiple plate bodies, and multiple pivot shafts;
Multiple plates and multiple shafts form a rotating cover, and the two ends of the rotating cover are respectively connected to a large front rail system and a rear rail;
The guide rail system is connected to both ends of the car cover body;
The large front rail system comprises a large front rail, a large front plate pad, and a front plate buckle. The large front rail is provided with a central hole and edge holes, and the edge holes of the large front rail are equipped with a front plate lock. The central hole of the large front rail corresponds to a front plate unlocking mechanism; By setting up a front panel unlocking mechanism, the unlocking mechanism can simultaneously drive two front panel locks to unlock, making it convenient to operate.

The rotating shaft comprises an intermediate rotating body and two connecting parts. The connecting part is used to connect the plate body, and the two connecting parts are connected by the intermediate rotating body. The intermediate rotating body is provided with a rotating shaft rubber strip protrusion.

An embedded hard cover, characterized by comprising a car cover body and a guide rail system, wherein the car cover body comprises a large front rail system, a large plate, a middle plate, a small plate, a first rotating shaft, a second rotating shaft, a guide rail system, and a rear rail:
One end of the large plate is connected to a large front rail system, and the other end of the large plate is connected between the middle plate through a first rotating shaft. The end of the middle plate away from the large plate is connected to the small plate through a second rotating shaft, and the small plate is connected to a rear rail;
The guide rail system is connected to both ends of the car cover body;
The large front rail system comprises a large front rail, a front large plate pad, and a front plate buckle. The large front rail is provided with a large front rail central hole and a large front rail edge hole, and the large front rail edge hole is equipped with a front plate lock. The large front rail central hole corresponds to a front plate unlocking mechanism; By setting up a front panel unlocking mechanism, the unlocking mechanism can simultaneously drive two front panel locks to unlock, making it convenient to operate.

The first rotating shaft comprises a right rotating shaft, a first rotating shaft rubber strip, a middle rotating shaft, a second rotating shaft rubber strip, and a left rotating shaft. The right rotating shaft and the middle rotating shaft are connected by the first rotating shaft rubber strip, and the left rotating shaft and the middle rotating shaft are connected by the second rotating shaft rubber strip. The upper surfaces of the first rotating shaft rubber strip and the second rotating shaft rubber strip are both provided with first rotating shaft rubber strip protrusions;

The second rotating shaft comprises a second rotating shaft left rod, a second rotating shaft middle rubber strip, and a second rotating shaft right rod. The second rotating shaft left rod and the second rotating shaft right rod are connected by the second rotating shaft middle rubber strip, and the second rotating shaft middle rubber strip is provided with a protrusion of the second rotating shaft rubber strip.

An embedded hard cover, characterized by comprising a hood body and a guide rail system, wherein the hood body comprises a large front rail system, a large plate, a middle plate, a small plate, a first pivot shaft, a third rotating shaft, a guide rail system, and a rear rail;
One end of the large plate is connected to a large front rail system, and the other end of the large plate is connected between the middle plate through a first rotating shaft. The end of the middle plate away from the large plate is connected to the small plate through a third rotating shaft, and the small plate is connected to a rear rail;
The guide rail system is connected to both ends of the car cover body;
The large front rail system comprises a large front rail, a front large plate pad, and a front plate buckle. The large front rail is provided with a large front rail central hole and a large front rail edge hole, and the large front rail edge hole is equipped with a front plate lock. The large front rail central hole is equipped with a front plate unlocking mechanism;
The first rotating shaft comprises a right rotating shaft, a first rotating shaft rubber strip, a middle rotating shaft, a second rotating shaft rubber strip, and a left rotating shaft. The right rotating shaft and the middle rotating shaft are connected by the first rotating shaft rubber strip, and the left rotating shaft and the middle rotating shaft are connected by the second rotating shaft rubber strip. The upper surfaces of the first rotating shaft rubber strip and the second rotating shaft rubber strip are both provided with first rotating shaft rubber strip protrusions, and the third rotating shaft has the same structure as the first rotating shaft.

The car cover can use any two pivot shafts, which can have the same or different structures, as long as they can ensure the smooth flipping of the car cover.

An embedded hard cover, characterized by comprising a car cover body and a guide rail system, wherein the car cover body comprises a large front rail system, a large plate, a middle plate, a small plate, a first rotating shaft, a second rotating shaft, a guide rail system, and a rear rail;
One end of the large plate is connected to a large front rail system, and the other end of the large plate is connected between the middle plate through a first rotating shaft. The end of the middle plate away from the large plate is connected to the small plate through a second rotating shaft, and the small plate is connected to a rear rail;
The guide rail system is connected to both ends of the car cover body;
The large front rail system comprises a large front rail, a front large plate pad, and a front plate buckle. The large front rail is provided with a large front rail edge hole, and a front plate fixing square head rod is provided inside the large front rail edge hole;
The first rotating shaft comprises a right rotating shaft, a first rotating shaft rubber strip, a middle rotating shaft, a second rotating shaft rubber strip, and a left rotating shaft. The right rotating shaft and the middle rotating shaft are connected by the first rotating shaft rubber strip, and the left rotating shaft and the middle rotating shaft are connected by the second rotating shaft rubber strip. The upper surfaces of the first rotating shaft rubber strip and the second rotating shaft rubber strip are both provided with first rotating shaft rubber strip protrusions;
The second rotating shaft comprises a second rotating shaft left rod, a second rotating shaft middle rubber strip, and a second rotating shaft right rod. The second rotating shaft left rod and the second rotating shaft right rod are connected by the second rotating shaft middle rubber strip, and the second rotating shaft middle rubber strip is provided with a protrusion of the second rotating shaft rubber strip.

An embedded hard cover, characterized by comprising a hood body and a guide rail system, wherein the hood body comprises a large front rail system, a large plate, a middle plate, a small plate, a first rotating shaft, a third rotating shaft, a guide rail system, and a rear rail;
One end of the large plate is connected to a large front rail system, and the other end of the large plate is connected between the middle plate through a first rotating shaft. The end of the middle plate away from the large plate is connected to the small plate through a second rotating shaft, and the small plate is connected to a rear rail;
The guide rail system is connected to both ends of the car cover body;
The large front rail system comprises a large front rail, a front large plate pad, and a front plate buckle. The large front rail is provided with a large front rail edge hole, and a front plate fixed square head rod is provided inside the large front rail edge hole;
The first rotating shaft comprises a right rotating shaft, a first rotating shaft rubber strip, a middle rotating shaft, a second rotating shaft rubber strip, and a left rotating shaft. The right rotating shaft and the middle rotating shaft are connected by the first rotating shaft rubber strip, and the left rotating shaft and the middle rotating shaft are connected by the second rotating shaft rubber strip. The upper surfaces of the first rotating shaft rubber strip and the second rotating shaft rubber strip are both provided with first rotating shaft rubber strip protrusions, and the third rotating shaft has the same structure as the first rotating shaft.

Furthermore, the front plate unlocking mechanism is connected to the plate body, and the front plate unlocking mechanism comprises a front rail steel wire, a handle fixing block, a fixing block crossbar, a front plate steel wire, and a front plate locking handle; The handle fixing block is connected to the main body of the car cover, and the handle fixing block is connected to a fixing block crossbar. The front rail steel wire is connected to the front panel lock, and the front rail steel wire is connected to the front panel lock handle through the front panel steel wire. The front panel lock handle is limited by the fixing block crossbar.

The car cover body is equipped with a front plate steel wire channel, and the front plate steel wire passes through the front plate steel wire channel.

The front panel lock can be opened and closed through the front panel unlocking mechanism. The front panel steel wire of the front panel unlocking mechanism is connected to the front rail steel wire. Simply pull the front panel lock handle to drive both front panel locks to move simultaneously. In order to ensure the stable position of the front panel lock handle, a fixed block crossbar can be used to limit the front panel lock handle and prevent it from slipping.

Furthermore, the large front rail edge hole corresponds to a front plate fixed square head rod, and the right rotating shaft is equipped with a front plate lock.

Furthermore, the large front rail edge hole is equipped with a front plate lock, and the right rotating shaft is equipped with a front plate fixed square head rod.

Furthermore, the front plate fixing square head rod comprises a front plate fixing square head and a plum blossom nut, the front plate fixing square head is connected to the large front rail edge hole or the right rotating shaft slot, the front plate fixing square head is provided with a threaded portion, and the threaded portion is connected to the plum blossom nut.

Furthermore, the guide rail system comprises a guide rail, a first guide rail rubber strip, a second guide rail rubber strip, a waterproof compensation sponge, and a guide rail back rubber strip;
The waterproof compensation sponge is located between the vehicle body and the guide rail back rubber strip on the back of the guide rail. The first guide rail rubber strip is provided with a rubber strip support surface, which is used to support the main body of the car cover. The first guide rail rubber strip is located on the upper plane of the guide rail. The second guide rail rubber strip includes a rubber strip waterproof blade, a rubber strip contact surface, and a rubber strip hollow structure. The second guide rail rubber strip is connected to the lower plane of the guide rail, and the rubber strip waterproof blade is connected to the lower side of the car cover. The rubber strip contact surface is in contact with the car cover, and the rubber strip hollow structure is a hollow structure. A water channel is formed between the hollow structure of the rubber strip and the guide rail.

There is a second guide rail adhesive strip between the lower plane of the guide rail and the main body of the car cover, which can provide waterproofing and buffering functions.

Furthermore, the guide rail comprises a first guide rail and a second guide rail, the first guide rail and the second guide rail are connected by a first clip component, and the connection between the first guide rail and the second guide rail is coated with sealant.

Furthermore, the width of the third middle rotating shaft of the third rotating shaft is equal to that of the third middle rotating shaft of the f first rotating shaft.

Furthermore, the third middle rotating shaft of the third rotating shaft is wider than the third middle rotating shaft of the first rotating shaft, and the other is narrower.

The two pivot shafts used in the main body of the car cover can have the same or different dimensions, and their structures can also be the same or different, just adjust them according to the specific vehicle model.

Furthermore, the right shaft comprises a right shaft deformation structure, a right shaft cavity, and a right shaft profile extrusion protrusion.

The right shaft cavity is used to connect the first shaft rubber strip finger, and the right shaft deformation structure is used to deform and compress the concave part of the first shaft rubber strip. Due to the need for deformation of the right shaft profile to compress the concave part of the first shaft rubber strip, this connection method makes the connection between the right shaft and the first shaft rubber strip more stable, and the first shaft rubber strip finger will not slide out of the right shaft cavity during use.

In addition, by setting the deformation structure of the right shaft, it is easier to achieve extrusion of the right shaft profile protrusion, and the deformed part during extrusion is relatively fixed, ensuring the stability of product quality.

Furthermore, the second rotating shaft comprises a left rod of the second rotating shaft, a middle rubber strip of the second rotating shaft, and a right rod of the second rotating shaft. The left rod of the second rotating shaft and the right rod of the second rotating shaft are connected by the middle rubber strip of the second rotating shaft. The left rod of the second rotating shaft is provided with a right rotating shaft deformation structure. When pressed, the upper side of the C profile undergoes deformation, and the right rotating shaft profile is pressed into the concave part of the second rotating shaft rubber strip on the middle rubber strip of the second rotating shaft to provide a waterproof effect. The concave part of the second rotating shaft rubber strip is a cavity for inserting the finger like body of the first rotating shaft rubber strip.

The beneficial effects of the present invention are: the present invention improves the overall hood by providing corresponding protrusions on the middle rubber strip of the first and second shafts, which can compensate for the above shortcomings and ensure the quality of the shaft rubber strip.

### ATTACHED IMAGE DESCRIPTION

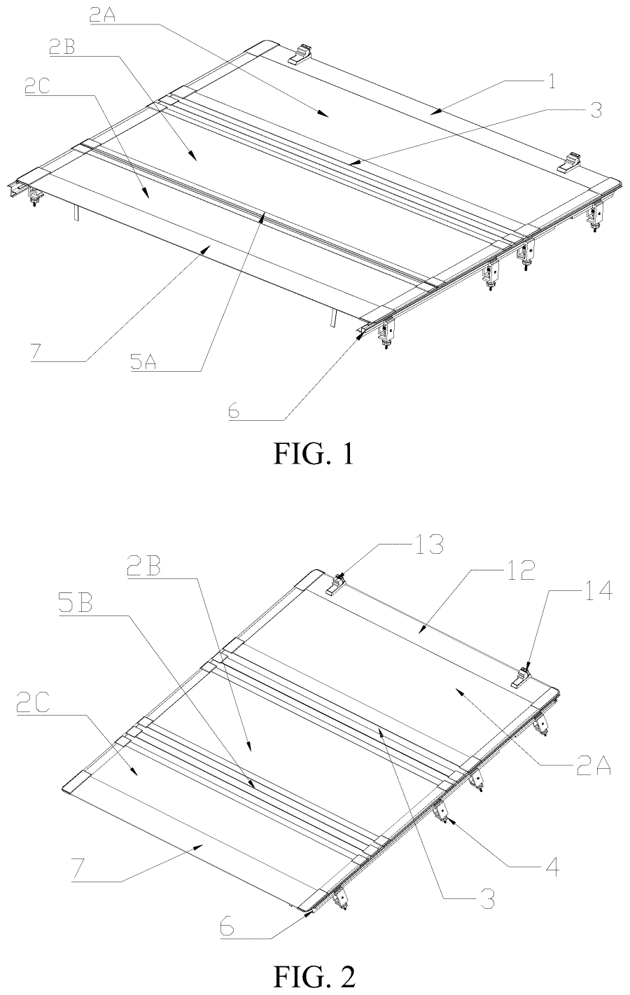

FIG. 1 is a schematic diagram of the structure of the present invention.

FIG. 2 is a schematic diagram of the structure of the present invention.

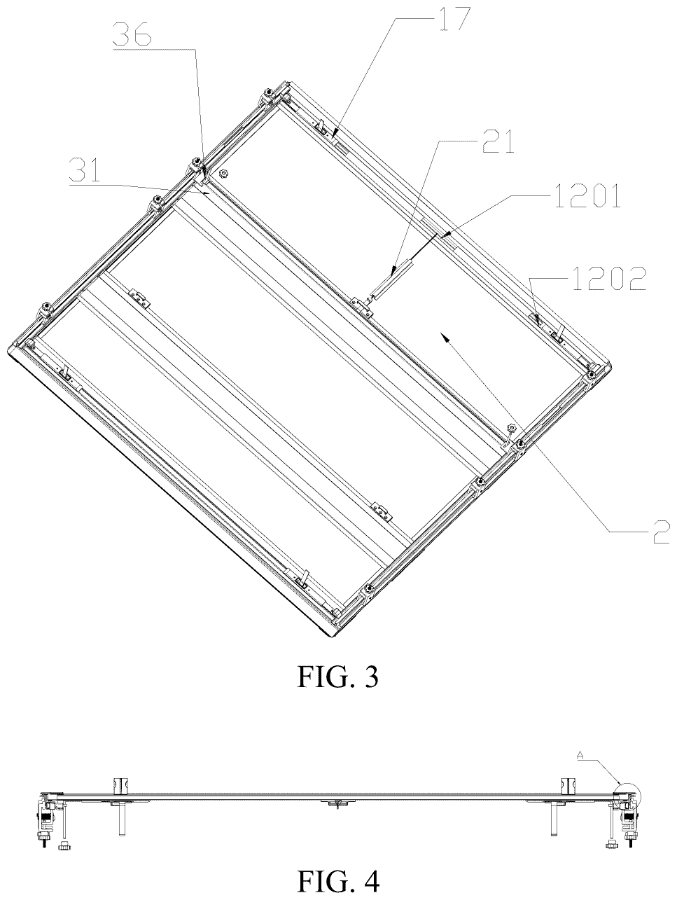

FIG. 3 is a schematic diagram of the structure of the present invention.

FIG. 4 is a schematic diagram of the structure of the present invention.

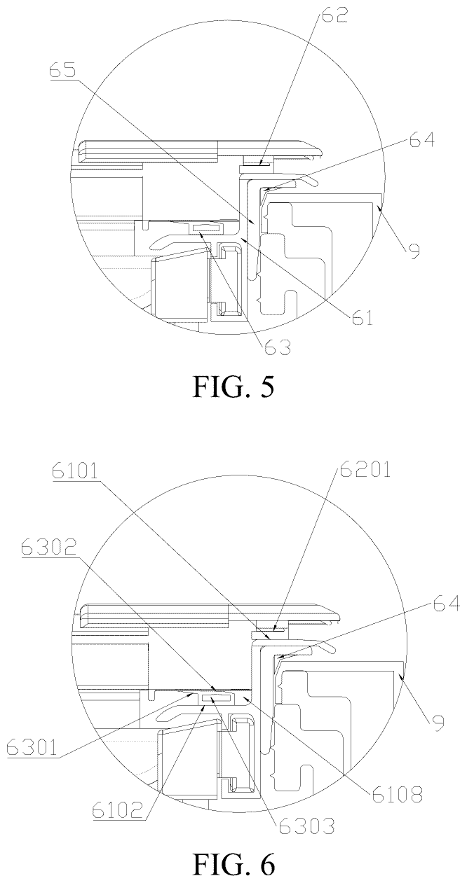

FIG. 5 is an enlarged partial view of part A in FIG. 4.

FIG. 6 is an enlarged partial view of part A in FIG. 4.

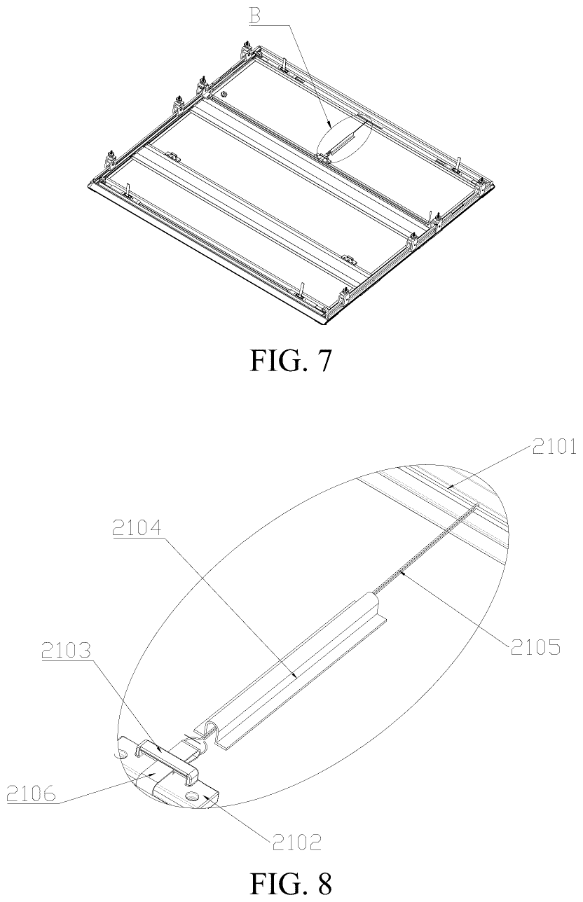

FIG. 7 is the fifth schematic diagram of the structure of the present invention.

FIG. 8 is an enlarged partial view of part B in FIG. 7.

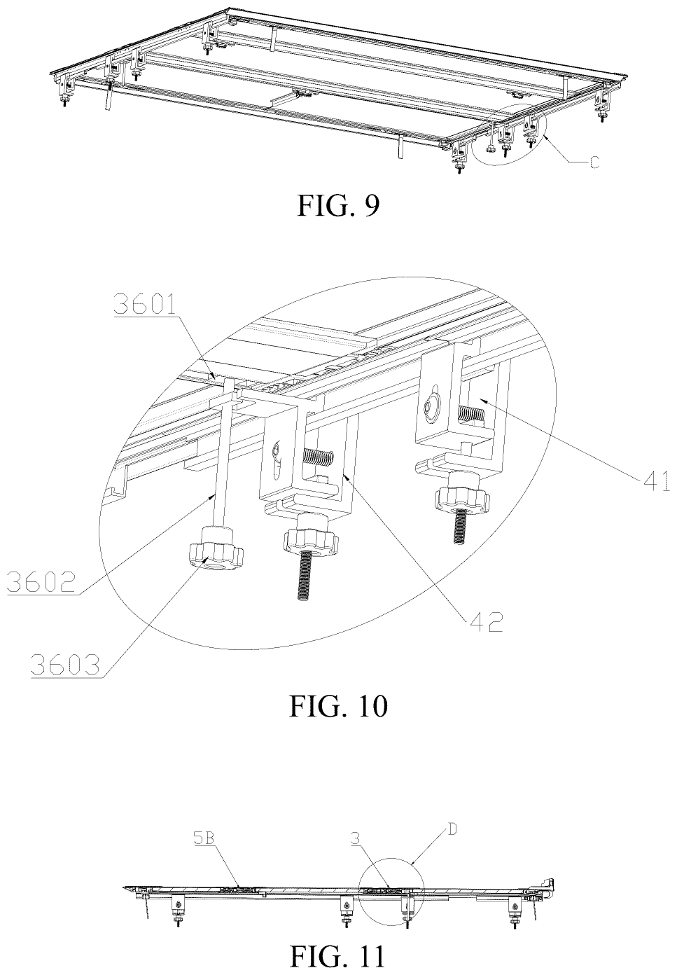

FIG. 9 is schematic diagram six of the structure of the present invention.

FIG. 10 is an enlarged partial view of part C in FIG. 9.

FIG. 11 is schematic diagram seven of the structure of the present invention.

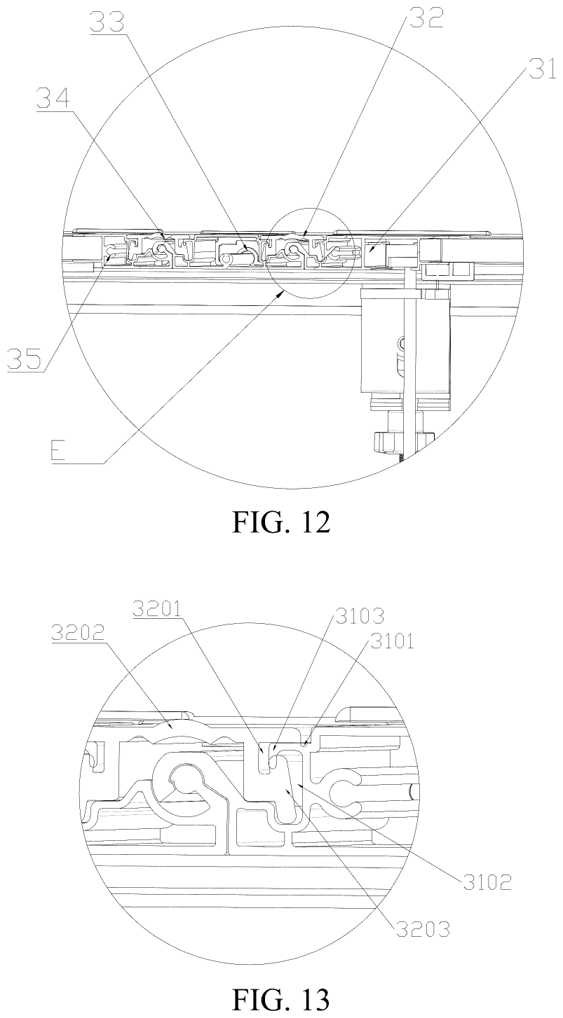

FIG. 12 is an enlarged partial view of part D in FIG. 11.

FIG. 13 is an enlarged partial view of section E in FIG. 12.

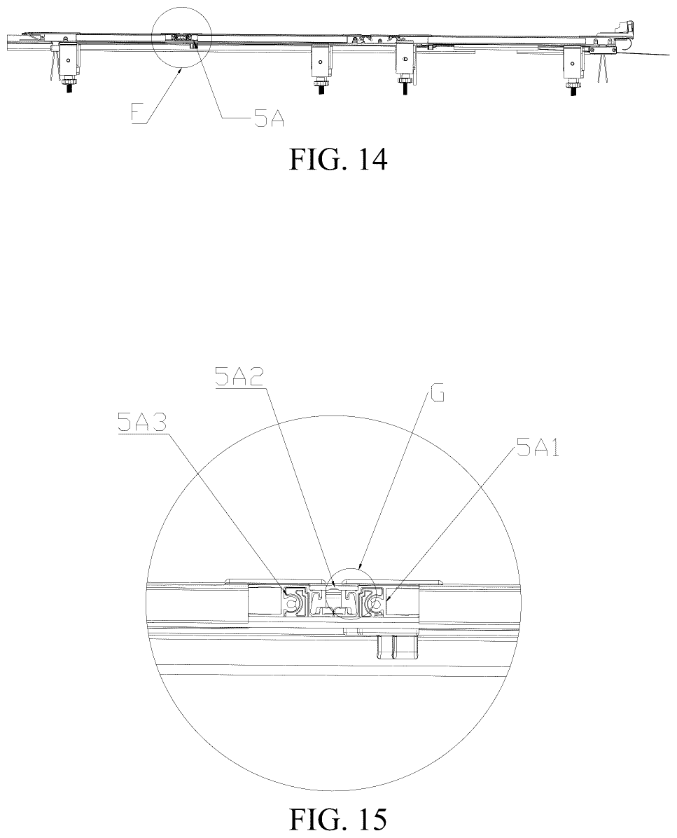

FIG. 14 is the eighth schematic diagram of the structure of the present invention.

FIG. 15 is an enlarged partial view of section F in FIG. 14.

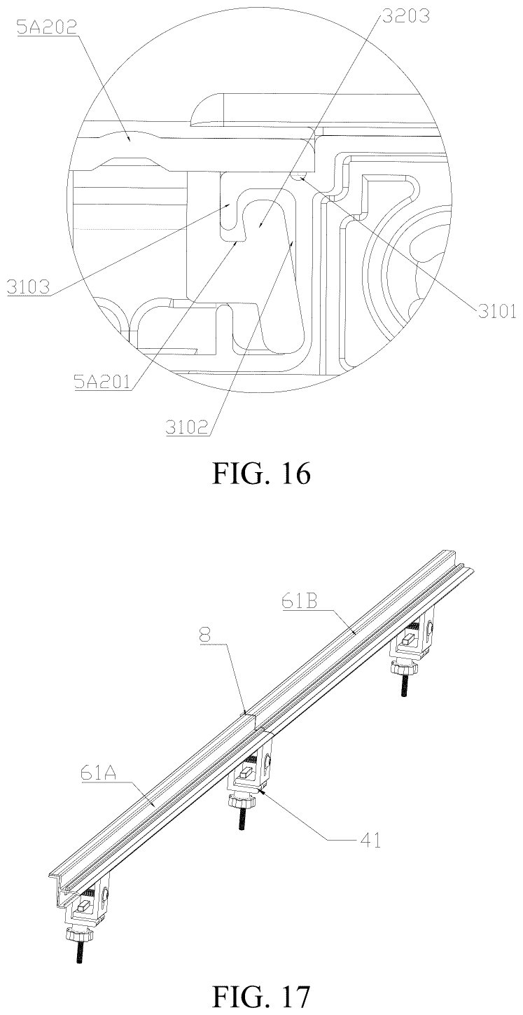

FIG. 16 is an enlarged partial view of section G in FIG. 12.

FIG. 17 is a schematic diagram of the guide rail connection in the present invention.

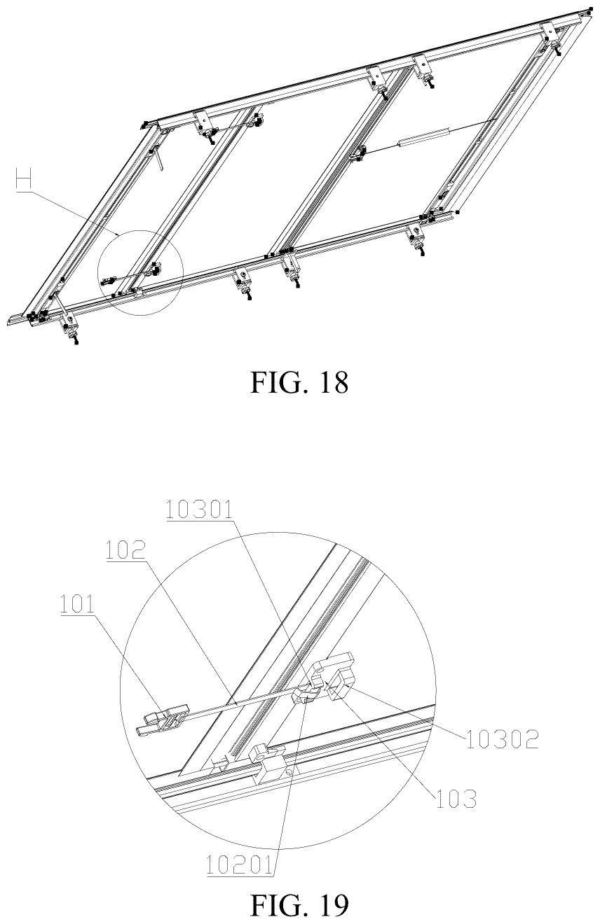

FIG. 18 is a schematic diagram of the connection of the buckle in the present invention.

FIG. 19 is an enlarged partial view of the H section in FIG. 18.

In the picture: 1—Large front rail system; 12—Large front rail; 1201—Large front rail central hole; 1202—Large front rail edge hole; 13—Front large plate pad; 14—Front plate buckle; 17—Front plate lock; 2—Plate body; 2A—Large plate; 2B—Middle plate; 2C—Small plate; 21—Front plate unlocking mechanism; 2101—Front rail steel wire; 2102—Handle fixing block; 2103—Fixing block crossbar; 2104—Front plate steel wire channel; 2105—Front plate steel wire; 2106 Front plate locking handle; 3—First rotating shaft; 31—Right rotating shaft; 3101—Right axis deformation structure; 3102—Right shaft cavity; 3103—Right shaft profile extrusion protrusion; 32—First rotating shaft rubber strip; 3201—First shaft rubber strip recess; 3202—First rotating shaft rubber strip protrusions; 3203—Rubber strip finger of first rotating shaft; 33—Middle rotating shaft; 34—Second rotating shaft rubber strip; 35—Left rotating shaft; 36—Front plate fixed square head rod; 3601—Front plate fixing square head; 3602—Threaded portion; 3603—Plum blossom nut; 4—Clip component; 41—First clip component; 42—Second clip component; 5A—Second rotating shaft; 5A1—Second rotating shaft left rod; 5A2—Second rotating shaft middle rubber strip; 5A201—Second rotating shaft rubber strip recess; 5A202—Second shaft rubber strip protrusion; 5A3—Second rotating shaft right rod; 5B—Third rotating shaft; 6—Guide rail system; 61—Guide rail; 61A—First guide rail; 61B—Second guide rail; 6101—Upper plane of the guide rail; 6102—Lower plane of the guide rail; 6108—Guide rail water channel; 62—First guide rail rubber strip; 6201—Rubber strip support surface; 63—Second guide rail rubber strip; 6301—Rubber strip waterproof blade; 6302—Rubber strip contact surface; 6303—Rubber strip hollow structure; 64—Waterproof compensation sponge; 65—Guide rail back rubber strip; 7—Rear rail; 8—sealant; 9—Vehicle body; 101—Buckle; 102—Webbing; 10201—Webbing binding ring; 103 buckle seat; 10301—Fixed binding rod; 10302—Buckle fixing port.

### Specific Implementation Method

The present invention will be further explained in conjunction with the accompanying drawings and reference numerals.

In order to better understand the above objectives, features, and advantages of the present invention, the present invention will be described in detail below in conjunction with the accompanying drawings and specific embodiments.

It should be noted that, without conflict, the embodiments and features of the present application can be combined with each other.

The terms‘first’,‘second’,‘third’, etc. are only used to distinguish descriptions and cannot be understood as indicating or implying relative importance.

In the description of the present invention, it should be noted that unless otherwise specified and limited, the terms “setting”, “installation”, “connection”, and “connection” should be broadly understood, for example, they can be fixed connections, detachable connections, or integral connections; It can be a mechanical connection or an electrical connection; It can be directly connected, indirectly connected through an intermediate medium, or connected internally between two components.

For ordinary technical personnel in this field, the specific meanings of the above terms in the present invention can be understood in specific situations.

The specific embodiments of the present invention will be described in detail below in conjunction with the accompanying drawings.

It should be understood that the specific embodiments described herein are only for illustrating and explaining the present invention, and are not intended to limit the present invention.

### Example 1

As shown in FIGS. 1, 2, 3, and 11-16, an embedded hard cover, characterized by comprising a car cover body and a guide rail system 6, wherein the car cover body comprises a large front rail system 1, a large plate 2A, a middle plate 2B, a small plate 2C, a first rotating shaft 3, a second rotating shaft 5A, a guide rail system 6, and a rear rail 7;
One end of the large plate 2A is connected to a large front rail system 1, and the other end of the large plate 2A is connected between the middle plate 2B through a first rotating shaft 3. The end of the middle plate 2B away from the large plate 2A is connected to the small plate 2C through a second rotating shaft 5A, and the small plate 2C is connected to a rear rail 7;
The guide rail system 6 is connected to both ends of the car cover body;
The large front rail system 1 comprises a large front rail 12, a front large plate pad 13, and a front plate buckle 14. The large front rail 12 is provided with a large front rail central hole 1201 and a large front rail edge hole 1202, and the large front rail edge hole 1202 is equipped with a front plate lock 17. The large front rail central hole 1201 corresponds to a front plate unlocking mechanism 21; (By setting the front plate unlocking mechanism 21, the unlocking mechanism can simultaneously drive two front panel locks 17 to unlock, making it convenient to operate.)

The first rotating shaft 3 comprises a right rotating shaft 31, a first rotating shaft rubber strip 32, a middle rotating shaft 33, a second rotating shaft rubber strip 34, and a left rotating shaft 35. The right rotating shaft 31 and the middle rotating shaft 33 are connected by the first rotating shaft rubber strip 32, and the left rotating shaft 35 and the middle rotating shaft 33 are connected by the second rotating shaft rubber strip 34. The upper surfaces of the first rotating shaft rubber strip 32 and the second rotating shaft rubber strip 34 are both provided with first rotating shaft rubber strip protrusions 3202;
The second rotating shaft 5A comprises a second rotating shaft left rod 5A1, a second rotating shaft middle rubber strip 5A2, and a second rotating shaft right rod 5A3. The second rotating shaft left rod 5A1 and the second rotating shaft right rod 5A3 are connected by the second rotating shaft middle rubber strip 5A2, and the second rotating shaft middle rubber strip 5A2 is provided with a protrusion of the second rotating shaft rubber strip 34.

During the flipping process of the car cover, long-term bending of the hinge rubber strip can cause local strength reduction, and secondly, folding of the hinge rubber strip can cause local sinking. Therefore, setting corresponding protrusions on the middle rubber strip between the first and second hinge rubber strips can compensate for the above shortcomings and ensure the quality of the hinge rubber strip.

(The large front rail 12 can be connected and fixed by the front plate lock 17, or by the front plate fixed square head rod 36, as long as the connection of the large front rail system 1 is stable.)

### Example 2

As shown in FIGS. 1, 2, 3, and 11-16, an embedded hard cover, characterized by comprising a hood body and a guide rail system 6, wherein the hood body comprises a large front rail system 1, a large plate 2A, a middle plate 2B, a small plate 2C, a first pivot shaft 3, a third rotating shaft 5B, a guide rail system 6, and a rear rail 7;
One end of the large plate 2A is connected to a large front rail system 1, and the other end of the large plate 2A is connected between the middle plate 2B through a first rotating shaft 3. The end of the middle plate 2B away from the large plate 2A is connected to the small plate 2C through a third rotating shaft 5B, and the small plate 2C is connected to a rear rail 7;
The guide rail system 6 is connected to both ends of the car cover body;
The large front rail system 1 comprises a large front rail 12, a front large plate pad 13, and a front plate buckle 14. The large front rail 12 is provided with a large front rail central hole 1201 and a large front rail edge hole 1202, and the large front rail edge hole 1202 is equipped with a front plate lock 17. The large front rail central hole 1201 is equipped with a front plate unlocking mechanism 21;
The first rotating shaft 3 comprises a right rotating shaft 31, a first rotating shaft rubber strip 32, a middle rotating shaft 33, a second rotating shaft rubber strip 34, and a left rotating shaft 35. The right rotating shaft 31 and the middle rotating shaft 33 are connected by the first rotating shaft rubber strip 32, and the left rotating shaft 35 and the middle rotating shaft 33 are connected by the second rotating shaft rubber strip 34. The upper surfaces of the first rotating shaft rubber strip 32 and the second rotating shaft rubber strip 34 are both provided with first rotating shaft rubber strip protrusions 3202, and the third rotating shaft 5B has the same structure as the first rotating shaft 3.

The car cover can use any two pivot shafts (any two of the first pivot shaft, second pivot shaft, and third pivot shaft), and the two pivot shafts can have the same or different structures, as long as they can ensure the smooth flipping of the car cover.

### Example 3

As shown in FIGS. 1, 2, 3, and 11-16, an embedded hard cover, characterized by comprising a car cover body and a guide rail system 6, wherein the car cover body comprises a large front rail system 1, a large plate 2A, a middle plate 2B, a small plate 2C, a first rotating shaft 3, a second rotating shaft 5A, a guide rail system 6, and a rear rail 7;
One end of the large plate 2A is connected to a large front rail system 1, and the other end of the large plate 2A is connected between the middle plate 2B through a first rotating shaft 3. The end of the middle plate 2B away from the large plate 2A is connected to the small plate 2C through a second rotating shaft 5A, and the small plate 2C is connected to a rear rail 7;
The guide rail system 6 is connected to both ends of the car cover body;
The large front rail system 1 comprises a large front rail 12, a front large plate pad 13, and a front plate buckle 14. The large front rail 12 is provided with a large front rail edge hole 1202, and a front plate fixing square head rod 36 is provided inside the large front rail edge hole 1202;
The first rotating shaft 3 comprises a right rotating shaft 31, a first rotating shaft rubber strip 32, a middle rotating shaft 33, a second rotating shaft rubber strip 34, and a left rotating shaft 35. The right rotating shaft 31 and the middle rotating shaft 33 are connected by the first rotating shaft rubber strip 32, and the left rotating shaft 35 and the middle rotating shaft 33 are connected by the second rotating shaft rubber strip 34. The upper surfaces of the first rotating shaft rubber strip 32 and the second rotating shaft rubber strip 34 are both provided with first rotating shaft rubber strip protrusions 3202;
The second rotating shaft 5A comprises a second rotating shaft left rod 5A1, a second rotating shaft middle rubber strip 5A2, and a second rotating shaft right rod 5A3. The second rotating shaft left rod 5A1 and the second rotating shaft right rod 5A3 are connected by the second rotating shaft middle rubber strip 5A2, and the second rotating shaft middle rubber strip 5A2 is provided with a protrusion of the second rotating shaft rubber strip 34.

### Example 4

As shown in FIGS. 1, 2, 3, and 11-16, an embedded hard cover, characterized by comprising a hood body and a guide rail system 6, wherein the hood body comprises a large front rail system 1, a large plate 2A, a middle plate 2B, a small plate 2C, a first rotating shaft 3, a third rotating shaft 5B, a guide rail system 6, and a rear rail 7;
One end of the large plate 2A is connected to a large front rail system 1, and the other end of the large plate 2A is connected between the middle plate 2B through a first rotating shaft 3. The end of the middle plate 2B away from the large plate 2A is connected to the small plate 2C through a second rotating shaft 5A, and the small plate 2C is connected to a rear rail 7;
The guide rail system 6 is connected to both ends of the car cover body;
The large front rail system 1 comprises a large front rail 12, a front large plate pad 13, and a front plate buckle 14. The large front rail 12 is provided with a large front rail edge hole 1202, and a front plate fixed square head rod 36 is provided inside the large front rail edge hole 1202;
The first rotating shaft 3 comprises a right rotating shaft 31, a first rotating shaft rubber strip 32, a middle rotating shaft 33, a second rotating shaft rubber strip 34, and a left rotating shaft 35. The right rotating shaft 31 and the middle rotating shaft 33 are connected by the first rotating shaft rubber strip 32, and the left rotating shaft 35 and the middle rotating shaft 33 are connected by the second rotating shaft rubber strip 34. The upper surfaces of the first rotating shaft rubber strip 32 and the second rotating shaft rubber strip 34 are both provided with first rotating shaft rubber strip protrusions 3202, and the third rotating shaft 5B has the same structure as the first rotating shaft 3.

### Example 5

On the basis of Examples 1 and 2, as shown in FIGS. 7 and 8, the front plate unlocking mechanism 21 is connected to the plate body 2 (Plate 2 includes a large plate 2A, a middle plate 2B, and a small plate 2C), and the front plate unlocking mechanism 21 comprises a front rail steel wire 2101, a handle fixing block 2102, a fixing block crossbar 2103, a front plate steel wire 2105, and a front plate locking handle 2106;
The handle fixing block 2102 is connected to the main body of the car cover, and is connected to a fixing block crossbar 2103. The front rail steel wire 2101 is connected to the front plate lock 17, and the front rail steel wire 2101 is connected to the front plate lock handle 2106 through the front plate steel wire 2105. The front plate lock handle 2106 is limited by the fixing block crossbar 2103.

The car cover body is equipped with a front plate steel wire channel 2104, and the front plate steel wire 2105 passes through the front plate steel wire channel 2104.

The front plate lock 17 can be opened and closed through the front plate unlocking mechanism 21. The front plate steel wire 2105 of the front plate unlocking mechanism 21 is connected to the front rail steel wire 2101. Simply pull the front plate lock handle 2106 to drive both front plate locks 17 to move simultaneously. In order to ensure the stable position of the front plate lock handle 2106, the fixing block crossbar 2103 can be used to limit the front plate lock handle 2106 and prevent it from slipping.

### Example 6

On the basis of embodiments 1 and 2, as shown in FIGS. 7 and 8, the large front rail edge hole 1202 corresponds to a front plate fixed square head rod 36, and the right rotating shaft 31 is equipped with a front plate lock 17.

### Example 7

Based on Examples 1 and 2, as shown in FIGS. 7 and 8, the large front rail edge hole 1202 is correspondingly provided with a front plate lock 17, and the right rotating shaft 31 is provided with a front plate fixed square head rod 36;

### Example 8

On the basis of embodiments 6 and 7, the front plate fixing square head rod 36 comprises a front plate fixing square head 3601 and a plum blossom nut 3603, the front plate fixing square head 3601 is connected to the large front rail edge hole 1202 or the right rotating shaft 31 slot, the front plate fixing square head 3601 is provided with a threaded portion 3602, and the threaded portion 3602 is connected to the plum blossom nut 3603, the front plate fixed square head rod 36 can be connected to the guide rail through the second clip component 42, and an extension plate can be added to the second clip component 42. Using the extension plate, the threaded portion 3602 passes through the extension plate, and the extension plate limits the plum blossom nut 3603.

The first clip component 41 and the second clip component 42 both belong to clip component 4, but their structures are different. The second clip component 42 can also be used to clamp the guide rail and the vehicle body.

### Example 9

On the basis of Examples 1-4, as shown in FIGS. 4-6, the guide rail system 6 comprises a guide rail 61, a first guide rail rubber strip 62, a second guide rail rubber strip 63, a waterproof compensation sponge 64, and a guide rail back rubber strip 65;
The waterproof compensation sponge 64 is located between the vehicle body and the guide rail back rubber strip 65 on the back of the guide rail. The first guide rail rubber strip 62 is provided with a rubber strip support surface 6201, which is used to support the main body of the car cover. The first guide rail rubber strip 62 is located on the upper plane of the guide rail 6101. The second guide rail rubber strip 63 includes a rubber strip waterproof blade 6301, a rubber strip contact surface 6302, and a rubber strip hollow structure 6303. The second guide rail rubber strip 63 is connected to the lower plane of the guide rail 6102, and the rubber strip waterproof blade 6301 is connected to the lower side of the car cover. The rubber strip contact surface 6302 is in contact with the car cover, and the rubber strip hollow structure 6303 is a hollow structure, the rubber strip hollow structure 6303 of the rubber strip forms a water guiding channel with the guide rail 61.

During installation, it is necessary to use clip component 4 to connect guide rail 61 to vehicle body 9. In order to ensure stability, a guide rail back rubber strip 65 will be installed between guide rail 61 and vehicle body 9. Due to the gap at the corner when connecting guide rail back rubber strip 65 to vehicle body 9, waterproof compensation sponge 64 can effectively compensate for this gap and provide a certain waterproof effect. In addition, a first gu guide rail rubber strip 62 is installed on the upper plane of the guide rail 6101 of the guide rail, and the car cover body is placed on the first guide rail rubber strip 62, which not only ensures stability but also has a good buffering effect, extending the service life of the car cover body and guide rail 61.

There is a second guide rail adhesive strip 63 between the lower plane of the guide rail 6102 of the guide rail and the main body of the car cover, which can provide waterproof and buffering functions.

Firstly, when the main body of the car cover is pressed onto the second guide rail rubber strip 63, it will also compress the rubber strip waterproof blade 6301 of the second guide rail rubber strip 63, making the rubber strip waterproof blade 6301 tightly adhere to the main body of the car cover, providing a good sealing effect;

Secondly, press the second guide rail rubber strip 63 tightly onto the car cover body and the right shaft cavity 3102 of the guide rail, so that a guide rail water channel 6108 is formed between the second guide rail rubber strip 63 and the guide rail 61, which can play a drainage role. With the dual effect of sealing and reverse drainage, the waterproof effect is better.

Finally, the second guide rail rubber strip 63 is equipped with a rubber strip hollow structure 6303, which can provide some deformation when the second guide rail rubber strip 63 is subjected to different forces, thus playing a good buffering role.

The guide rail 61 comprises a first guide rail 61A and a second guide rail 61B, the first guide rail 61A and the second guide rail 61B are connected by a first clip component 41, and the connection between the first guide rail 61A and the second guide rail 61B is coated with sealant 8.

If the guide rail 61 adopts a whole structure from beginning to end, it will greatly increase the size of the guide rail 61, thereby increasing transportation costs. This product is mainly used in the US market, where shipping costs are very high. Using segmented guide rails 61 can greatly reduce transportation costs.

When in use, simply use the first clip component 41 to connect the first guide rail 61A and the second guide rail 61B, reducing the production of finished products while ensuring product quality.

### Example 10

Based on Examples 2 and 4, as shown in FIG. 17, the width of the third middle rotating shaft 33 of the third rotating shaft 5B is equal to that of the third middle rotating shaft 33 of the f first rotating shaft 3.

### Example 11

Based on Examples 2 and 4, as shown in FIG. 17, the third middle rotating shaft 33 of the third rotating shaft 5B is wider than the third middle rotating shaft 33 of the first rotating shaft 3, and the other is narrower.

The two pivot shafts used in the main body of the car cover can have the same or different dimensions, and their structures can also be the same or different, just adjust them according to the specific vehicle model.

### Example 12

On the basis of Examples 1-4, the right rotating shaft 31 comprises a right axis deformation structure 3101, a right shaft cavity 3102, and a right shaft profile extrusion protrusion 3103.

When pressing occurs, the upper side of the C profile undergoes deformation. The compression protrusion 3103 of the right shaft profile presses into the first shaft rubber strip recess 3201 of the first rotating shaft rubber strip 32 to provide waterproof effect. The right shaft cavity 3102 is a cavity used to insert the rubber strip finger of first rotating shaft 3203 of the first shaft rubber strip.

The right shaft cavity 3102 is used to connect the rubber strip finger of first rotating shaft 3203, and the right axis deformation structure 3101 is used to deform and compress the first shaft rubber strip reces 3201;

Due to the deformation required by the extrusion protrusion 3103 of the right shaft profile to compress the first shaft rubber strip recess 3201 of the first shaft rubber strip, this connection method makes the connection between the right rotating shaft 31 and the first rotating shaft rubber strip 32 more stable. During use, the rubber strip finger of first rotating shaft 3203 of the first shaft rubber strip will not slide out of the right shaft cavity 3102.

In addition, by setting the right axis deformation structure 3101, the right shaft profile extrusion protrusion 3103 of the right axis profile is easier to achieve extrusion, and the deformed part during extrusion is relatively fixed, ensuring the stability of product quality.

### Example 13

On the basis of embodiments 1 and 3, the second rotating shaft 5A includes a second rotating shaft left rod 5A1, a second rotating shaft middle rubber strip 5A2, and a second rotating shaft right rod 5A3. The second rotating shaft left rod 5A1 and the second rotating shaft right rod 5A3 are connected by the second rotating shaft middle rubber strip 5A2. The second rotating shaft left rod 5A1 is provided with a right axis deformation structure 3101. When pressed, the upper side of the C profile deforms, and the right shaft profile extrusion protrusion 3103 presses into the second rotating shaft middle rubber strip 5A2. The second rotating shaft rubber strip recess 5A201 has a waterproof effect, and each rotating shaft is provided with a deformation structure at the rotation point (similar to the right axis deformation structure). 3101), the second rotating shaft rubber strip recess 5A201 of the second rotating shaft rubber strip is a cavity used to insert the rubber strip finger of first rotating shaft 3203 of the first rotating shaft rubber strip.

The second rotating shaft middle rubber strip 5A2 is provided with a second rotating shaft rubber strip protrusion 5A202. The second rotating shaft rubber strip protrusion 5A202 is used to strengthen the strength of the middle rubber strip when folded, and secondly, the middle rubber strip will be concave after folding to fill the depression.

### Example 14

On the basis of Examples 1-4, it further comprises a buckle component, which comprises a buckle 101, a webbing 102, and a buckle seat 103. One end of the webbing 102 is connected to the buckle 101, and the other end of the webbing 102 is provided with a webbing binding ring 10201. The buckle seat 103 is connected to the main body of the car cover, and is provided with a fixed binding rod 10301 and a buckle fixing port 10302. The webbing binding ring 10201 is connected to the fixed binding rod 10301, and the buckle is fixed. The buckle fixing port 10302 is compatible with the buckle 101.

The present invention is not limited to the above optional embodiments, and anyone can derive various forms of products from the inspiration of the present invention. However, regardless of any changes in its shape or structure, any technical solution that falls within the scope of the claims of the present invention is within the scope of protection of the present invention.

1. An embedded hard cover, characterized by comprising a car cover body and a guide rail system (6), wherein the car cover body comprises a large front rail system (1), a large plate (2A), a middle plate (2B), a small plate (2C), a first rotating shaft (3), a second rotating shaft (5A), a guide rail system (6), and a rear rail (7);
One end of the large plate (2A) is connected to a large front rail system (1), and the other end of the large plate (2A) is connected between the middle plate (2B) through a first rotating shaft (3). The end of the middle plate (2B) away from the large plate (2A) is connected to the small plate (2C) through a second rotating shaft (5A), and the small plate (2C) is connected to a rear rail (7);
The guide rail system (6) is connected to both ends of the car cover body;
The large front rail system (1) comprises a large front rail (12), a front large plate pad (13), and a front plate buckle (14). The large front rail (12) is provided with a large front rail central hole (1201) and a large front rail edge hole (1202), and the large front rail edge hole (1202) is equipped with a front plate lock (17). The large front rail central hole (1201) corresponds to a front plate unlocking mechanism (21);
The first rotating shaft (3) comprises a right rotating shaft (31), a first rotating shaft rubber strip (32), a middle rotating shaft (33), a second rotating shaft rubber strip (34), and a left rotating shaft (35). The right rotating shaft (31) and the middle rotating shaft (33) are connected by the first rotating shaft rubber strip (32), and the left rotating shaft (35) and the middle rotating shaft (33) are connected by the second rotating shaft rubber strip (34). The upper surfaces of the first rotating shaft rubber strip (32) and the second rotating shaft rubber strip (34) are both provided with first rotating shaft rubber strip protrusions (3202);
The second rotating shaft (5A) comprises a second rotating shaft left rod (5A1), a second rotating shaft middle rubber strip (5A2), and a second rotating shaft right rod (5A3). The second rotating shaft left rod (5A1) and the second rotating shaft right rod (5A3) are connected by the second rotating shaft middle rubber strip (5A2), and the second rotating shaft middle rubber strip (5A2) is provided with a protrusion of the second rotating shaft rubber strip (34).

2. An embedded hard cover, characterized by comprising a hood body and a guide rail system (6), wherein the hood body comprises a large front rail system (1), a large plate (2A), a middle plate (2B), a small plate (2C), a first pivot shaft (3), a third rotating shaft (5B), a guide rail system (6), and a rear rail (7);
One end of the large plate (2A) is connected to a large front rail system (1), and the other end of the large plate (2A) is connected between the middle plate (2B) through a first rotating shaft (3). The end of the middle plate (2B) away from the large plate (2A) is connected to the small plate (2C) through a third rotating shaft (5B), and the small plate (2C) is connected to a rear rail (7);
The guide rail system (6) is connected to both ends of the car cover body;
The large front rail system (1) comprises a large front rail (12), a front large plate pad (13), and a front plate buckle (14). The large front rail (12) is provided with a large front rail central hole (1201) and a large front rail edge hole (1202), and the large front rail edge hole (1202) is equipped with a front plate lock (17). The large front rail central hole (1201) is equipped with a front plate unlocking mechanism (21);
The first rotating shaft (3) comprises a right rotating shaft (31), a first rotating shaft rubber strip (32), a middle rotating shaft (33), a second rotating shaft rubber strip (34), and a left rotating shaft (35). The right rotating shaft (31) and the middle rotating shaft (33) are connected by the first rotating shaft rubber strip (32), and the left rotating shaft (35) and the middle rotating shaft (33) are connected by the second rotating shaft rubber strip (34). The upper surfaces of the first rotating shaft rubber strip (32) and the second rotating shaft rubber strip (34) are both provided with first rotating shaft rubber strip protrusions (3202), and the third rotating shaft (5B) has the same structure as the first rotating shaft (3).

3. The embedded hard cover according to claim 1 or 2, characterized in that: the front plate unlocking mechanism (21) is connected to the plate body (2), and the front plate unlocking mechanism (21) comprises a front rail steel wire (2101), a handle fixing block (2102), a fixing block crossbar (2103), a front plate steel wire (2105), and a front plate locking handle (2106);
The handle fixing block (2102) is connected to the main body of the car cover, and is connected to a fixing block crossbar (2103). The front rail steel wire (2101) is connected to the front plate lock (17), and the front rail steel wire (2101) is connected to the front plate lock handle (2106) through the front plate steel wire (2105). The front plate lock handle (2106) is limited by the fixing block crossbar (2103).
The car cover body is equipped with a front plate steel wire channel (2104), and the front plate steel wire (2105) passes through the front plate steel wire channel (2104).

4. The embedded hard cover according to claim 1 or 2, characterized in that: the large front rail edge hole (1202) is correspondingly provided with a front plate lock (17), and the right rotating shaft (31) is provided with a front plate fixed square head rod (36).

5. The embedded hard cover according to claim 3, characterized in that the front plate fixing square head rod (36) comprises a front plate fixing square head (3601) and a plum blossom nut (3603), the front plate fixing square head (3601) is connected to the large front rail edge hole (1202) or the right rotating shaft (31) slot, the front plate fixing square head (3601) is provided with a threaded portion (3602), and the threaded portion (3602) is connected to the plum blossom nut (3603).

6. An embedded hard cover, characterized by comprising a car cover body and a guide rail system (6), wherein the car cover body comprises a large front rail system (1), a large plate (2A), a middle plate (2B), a small plate (2C), a first rotating shaft (3), a second rotating shaft (5A), a guide rail system (6), and a rear rail (7);
One end of the large plate (2A) is connected to a large front rail system (1), and the other end of the large plate (2A) is connected between the middle plate (2B) through a first rotating shaft (3). The end of the middle plate (2B) away from the large plate (2A) is connected to the small plate (2C) through a second rotating shaft (5A), and the small plate (2C) is connected to a rear rail (7);
The guide rail system (6) is connected to both ends of the car cover body;
The large front rail system (1) comprises a large front rail (12), a front large plate pad (13), and a front plate buckle (14). The large front rail (12) is provided with a large front rail edge hole (1202), and a front plate fixing square head rod (36) is provided inside the large front rail edge hole (1202);
The first rotating shaft (3) comprises a right rotating shaft (31), a first rotating shaft rubber strip (32), a middle rotating shaft (33), a second rotating shaft rubber strip (34), and a left rotating shaft (35). The right rotating shaft (31) and the middle rotating shaft (33) are connected by the first rotating shaft rubber strip (32), and the left rotating shaft (35) and the middle rotating shaft (33) are connected by the second rotating shaft rubber strip (34). The upper surfaces of the first rotating shaft rubber strip (32) and the second rotating shaft rubber strip (34) are both provided with first rotating shaft rubber strip protrusions (3202);
The second rotating shaft (5A) comprises a second rotating shaft left rod (5A1), a second rotating shaft middle rubber strip (5A2), and a second rotating shaft right rod (5A3). The second rotating shaft left rod (5A1) and the second rotating shaft right rod (5A3) are connected by the second rotating shaft middle rubber strip (5A2), and the second rotating shaft middle rubber strip (5A2) is provided with a protrusion of the second rotating shaft rubber strip (34).

7. The embedded hard cover according to any one of claim 1 or 6, characterized in that: the second rotating shaft (5A) comprises a second rotating shaft left rod (5A1), a second rotating shaft middle rubber strip (5A2), and a second rotating shaft right rod (5A3), the second rotating shaft left rod (5A1) and the second rotating shaft right rod (5A3) are connected by a second rotating shaft middle rubber strip (5A2), and the second rotating shaft left rod (5A1) is provided with a right axis deformation structure (3101).

8. An embedded hard cover, characterized by comprising a hood body and a guide rail system (6), wherein the hood body comprises a large front rail system (1), a large plate (2A), a middle plate (2B), a small plate (2C), a first rotating shaft (3), a third rotating shaft (5B), a guide rail system (6), and a rear rail (7);
One end of the large plate (2A) is connected to a large front rail system (1), and the other end of the large plate (2A) is connected between the middle plate (2B) through a first rotating shaft (3). The end of the middle plate (2B) away from the large plate (2A) is connected to the small plate (2C) through a second rotating shaft (5A), and the small plate (2C) is connected to a rear rail (7);
The guide rail system (6) is connected to both ends of the car cover body;
The large front rail system (1) comprises a large front rail (12), a front large plate pad (13), and a front plate buckle (14). The large front rail (12) is provided with a large front rail edge hole (1202), and a front plate fixed square head rod (36) is provided inside the large front rail edge hole (1202);
The first rotating shaft (3) comprises a right rotating shaft (31), a first rotating shaft rubber strip (32), a middle rotating shaft (33), a second rotating shaft rubber strip (34), and a left rotating shaft (35). The right rotating shaft (31) and the middle rotating shaft (33) are connected by the first rotating shaft rubber strip (32), and the left rotating shaft (35) and the middle rotating shaft (33) are connected by the second rotating shaft rubber strip (34). The upper surfaces of the first rotating shaft rubber strip (32) and the second rotating shaft rubber strip (34) are both provided with first rotating shaft rubber strip protrusions (3202), and the third rotating shaft (5B) has the same structure as the first rotating shaft (3).

9. The embedded hard cover according to claim 6 or 8, characterized in that: the large front rail edge hole (1202) is correspondingly provided with a front plate fixed square head rod (36), and the right rotating shaft (31) is provided with a front plate lock (17).

10. The embedded hard cover according to claim 9, characterized in that the front plate fixing square head rod (36) comprises a front plate fixing square head (3601) and a plum blossom nut (3603), the front plate fixing square head (3601) is connected to the large front rail edge hole (1202) or the right rotating shaft (31) slot, the front plate fixing square head (3601) is provided with a threaded portion (3602), and the threaded portion (3602) is connected to the plum blossom nut (3603).

11. The embedded hard cover according to any one of claims 1, 2, 6, and 8, characterized in that the guide rail system (6) comprises a guide rail (61), a first guide rail rubber strip (62), a second guide rail rubber strip (63), a waterproof compensation sponge (64), and a guide rail back rubber strip (65);
The waterproof compensation sponge (64) is located between the vehicle body and the guide rail back rubber strip (65) on the back of the guide rail. The first guide rail rubber strip (62) is provided with a rubber strip support surface (6201), which is used to support the main body of the car cover. The first guide rail rubber strip (62) is located on the upper plane of the guide rail (6101). The second guide rail rubber strip (63) includes a rubber strip waterproof blade (6301), a rubber strip contact surface (6302), and a rubber strip hollow structure (6303). The second guide rail rubber strip (63) is connected to the lower plane of the guide rail (6102), and the rubber strip waterproof blade (6301) is connected to the lower side of the car cover. The rubber strip contact surface (6302) is in contact with the car cover, and the rubber strip hollow structure (6303) is a hollow structure.

12. The embedded hard cover according to any one of claims 1, 2, 6, and 8, characterized in that the guide rail (61) comprises a first guide rail (61A) and a second guide rail (61B), the first guide rail (61A) and the second guide rail (61B) are connected by a first clip component (41), and the connection between the first guide rail (61A) and the second guide rail (61B) is coated with sealant (8).

13. The embedded hard cover according to any one of claim 2 or 8, characterized in that the width of the third middle rotating shaft (33) of the third rotating shaft (5B) is equal to that of the third middle rotating shaft (33) of the f first rotating shaft (3).

14. The embedded hard cover according to any one of claim 2 or 8, characterized in that: the third middle rotating shaft (33) of the third rotating shaft (5B) is wider than the third middle rotating shaft (33) of the first rotating shaft (3), and the other is narrower.

15. The embedded hard cover according to any one of claims 1, 2, 6, and 8, characterized in that the right rotating shaft (31) comprises a right axis deformation structure (3101), a right shaft cavity (3102), and a right shaft profile extrusion protrusion (3103).

16. The embedded hard cover according to any one of claims 1, 2, 6, and 8, characterized in that it further comprises a buckle component, which comprises a buckle (101), a webbing (102), and a buckle seat (103). One end of the webbing (102) is connected to the buckle (101), and the other end of the webbing (102) is provided with a webbing binding ring (10201). The buckle seat (103) is connected to the main body of the car cover, and is provided with a fixed binding rod (10301) and a buckle fixing port (10302). The webbing binding ring (10201) is connected to the fixed binding rod (10301), and the buckle is fixed. The buckle fixing port (10302) is compatible with the buckle (101).
